(19) United States
(12) Patent Application Publication
(10) Pub. No.: US 2016/0316637 A1
(43) Pub. Date: Nov. 3, 2016

(54) Modular Growing System

(71) Applicant: Thomas J. Leone, Lakewood, CO (US)

(72) Inventor: Thomas J. Leone, Lakewood, CO (US)

(21) Appl. No.: 14/701,516

(22) Filed: Apr. 30, 2015

(51) Int. Cl. A01G 9/02; A01G 1/00; A01G 7/04; A01G 27/02; A01G 27/06

(52) U.S. Cl. CPC A01G 9/02; A01G 27/02; A01G 27/06; A01G 7/045; A01G 1/001

(57) ABSTRACT

Disclosed is a portable, modular growing system with interchangeable parts comprising interlocking frames, a reservoir that sits on the ground, said reservoir further comprising a small obtrusion for viewing water levels and adding water, a planting guide or weed cover, a clear or “cold frame” cover with vents, a perforated flat panel that sits in the bottom of the connected frames and on top of the reservoir; and one or many wicking tubes. This invention relates to indoor and outdoor gardening, and novel ways of carrying out one or both. Disclosed is a novel modular device and system that carries out all stages of growing of the growing process indoors or outdoors and is suitable for small spaces. The system and device is ideal for home gardening as well as more industrial locations where space is limited such as restaurants as well as many other places. The modular system is comprised of a series of components that may be utilized to form raised beds, container gardens, cold frames and seed starters. The components are made of a system of modular interchangeable parts, such parts comprising frames and flat panels that may be used to assemble a garden appropriate for the season or growing stage (i.e. seed starter, production garden, cold frame, etc). Additional optional accessories or devices may be available.

### CROSS-REFERENCE TO RELATED APPLICATIONS & CONTINUITY DATA

Provisional for same filed May 15, 2014. EFS: 19045984. Application: 61/994,043

### STATEMENT REGARDING FEDERALLY SPONSORED RESEARCH OR DEVELOPMENT

N/A

### REFERENCE TO SEQUENTIAL LISTING, A TABLE, OR A COMPUTER PROGRAM LISTING APPENDIX SUBMITTED ON A COMPACT DISC

N/A

### BACKGROUND OF THE INVENTION

While there are a number of raised bed and container garden solutions available, none of them combine to form a complete growing system. The problem that this resolves is the need for multiple and independent growing systems, the space and size of using multiple independent systems. The invention herein comprises a system of modular interchangeable parts including frames and flat panels that are used to assemble a garden appropriate for the season or growing stage (e.g., seed starter, production garden, cold frame, etc.). This system combines all of the functionality and benefits of seed starting, self-watering, raised beds, production gardens, and cold frames into one interchangeable, and reusable system. Thus, there remains a considerable need for a portable, modular system that fits all the needs of the various growing seasons and gardening goals.

### FIELD OF THE INVENTION

The invention relates to home gardening systems and portable or indoor gardening.

### BACKGROUND PRIOR ART

The following is a list of some prior art that presently appears relevant
CN202873410U
EP0288192A1
EP1955587A1
U.S. Pat. No. 5,400,544
U.S. Pat. No. 7,856,755
U.S. Pat. No. 7,966,768
U.S. Pat. No. 8,341,884
US20020121048
US20120096766
US20130000197
U.S. Pat. No. 7,533,491 B2

### SUMMARY OF THE INVENTION

This invention relates to indoor and outdoor gardening, and novel ways of carrying out one or both. Disclosed is a novel modular device and system that carries out all stages of growing of the growing process in small spaces indoors or outdoors. The system and device is ideal for home gardening as well as more industrial locations where space is limited such as restaurants as well as many other places. The modular system is comprised of a series of components that may be utilized to form raised beds, container gardens, cold frames and seed starters. The components are made of a system of modular interchangeable parts, such parts comprising frames and flat panels that may be used to assemble a garden appropriate for the season or growing stage (i.e. seed starter, production garden, cold frame, etc.).

The invention herein enables growing in numerous places in multiple modes, and saves time and money for the home gardener. The system can be used by all but is especially useful for home gardeners with no room for traditional raised beds and who want to do production gardening on a patio or balcony or rooftop for example. The growing system herein also has commercial value for restaurants or other industrial or commercial entities wishing to grow ingredients (such as herbs, lettuces, etc.) on the premises to be used in their menus or offerings.

The invention herein solves, among others, the following problems:
It provides portability not available in raised beds.
It has a small footprint for providing production gardens in smaller spaces, that is, it provides for a raised bed-like production growing environment on rooftop, deck, patio, etc. (i.e., while it can be used in a yard no yard is needed).
It is self-watering and you can see at a glance if watering (i.e. reservoir refill) is required and overwatering is avoided.
It is easy to add fertilizer (water soluble or other) in the right amounts throughout growing season.
The removable components make it easier to succession plant in terms of removing exhausted crops and prepping for new ones.
It provides one system that takes plants from seed to cold weather crop harvest without the need to transplant thereby minimizing shock to plants.

The system is comprised of a set of interlocking frames, flat panels (perforated, clear vented cover, planting guides/weed cover), reservoir and tubing (wicking tubes, support scaffold) that when combined will create a growing system to take plants from seed to harvest.

A typical progression in certain embodiments might be as follows:
1. Create a seed starter tray that is used to start seed
2. Then combine the seed starter with a cold frame to harden plants off
3. Once hardened remove the cold frame top and seed starter is combined with additional frames to form raised beds and support scaffolding can be added for plant support for the active production garden
4. Once primary growing season is over replant the garden with cold weather crops and bring back the cold frame for protection against frost.

Additional optional accessories or devices may be available.

### BRIEF DESCRIPTION OF THE DRAWINGS AND FIGURES

FIG. 1. The basic frame is shown. 4 frames interlock to form the raised bed component.

FIG. 2. This is a completed raised bed component where 4 frames have been assembled.

FIG. 3. Shown is a wicking tube, wicking tubes may sit in the reservoir and may be made of any appropriate material such as plastic, metal, rubber, wood, and others. Wicking tubes will be recognized by those skilled in the art as being filled with growing medium and allowing seeping of water through its side into the growing medium.

FIG. 4. Shown is a clear or cold frame cover with vents. Clear is needed to let light in, for seed starting vents are closed and it helps retain humidity/moisture. For cold frame application it protects against frost and vents are open or closed depending on time of day and/or weather.

FIG. 5. Shown is a perforated flat panel which may sit in the bottom of the connected frames (and above the reservoir) and the wicking tubes connect into it. For seed starting this can be made of cardboard or another degradable material. The perforated panel is permanent (plastic or other suitable material) in the production garden mode, the cardboard perforated panel is used in seed start configuration because it will break down, this allows the seed starter tray/configuration to be placed on top of another production garden frame set once the seeds have sprouted and eventually the cardboard degrades, like the permanent perforated panel the cardboard has holes that allow the roots to permeate to the deeper part of the bed.

FIG. 6. Shown is the reservoir component. The frames may connect into this piece. The reservoir component comprises a lip surrounding it on all sides sufficient to contain liquid and support the frames and at least one obtrusion of varying size continuous with the reservoir bottom. Additionally the angle of the bottom of the obtrusion area may be even with the rest of the reservoir bottom. In alternative embodiments the obtrusion may be at a slight incline to enable indicating when water is below a threshold level.

FIG. 7. Shown is one embodiment of the basic assembly. 8 frames are used in this embodiment, 1 clear cover, 1 perforated flat panel, 1 reservoir, 3 wicking tubes. 8 frames enabling the cold frame functionality. A minimum of 4 frames could be used if no cold frame is desired. In this image, the soil or growing medium would go above perforated panel and water below. In further embodiments the dimensions may vary. Note the position of the obtrusion from the reservoir in relation to the frames above it, the obtrusion remains visible and accessible from the outside.

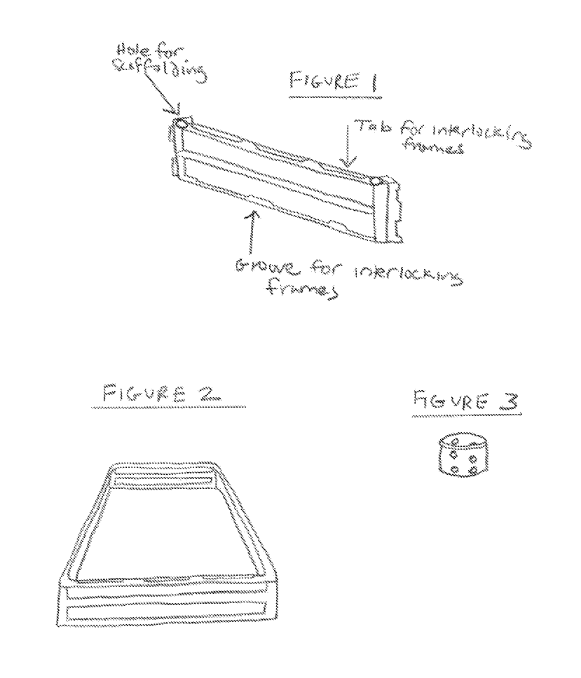

### DETAILED DESCRIPTION OF THE PREFERRED EMBODIMENTS

This invention relates to indoor and outdoor gardening, and novel ways of carrying out one or both. Disclosed is a novel modular device and system that carries out all stages of the growing process in small spaces indoors or outdoors. The system and device is ideal for home gardening as well as more industrial locations where space is limited such as restaurants as well as many other places. The modular system is comprised of a series of components that may be utilized to form raised beds, container gardens, cold frames and seed starters. The components are made of a system of modular interchangeable parts, such parts comprising frames and flat panels that may be used to assemble a garden appropriate for the season or growing stage (i.e. seed starter, production garden, cold frame, etc.). Flat panels herein are defined as the essentially flat components visible in the figures.

The invention herein enables growing in numerous places in multiple modes, and saves time and money for the home gardener. The system can be used by all but is especially useful for home gardeners with no room for traditional raised beds and who want to do production gardening on a patio or balcony or rooftop for example. The growing system herein also has commercial value for restaurants or other industrial or commercial entities wishing to grow ingredients (such as herbs, lettuces, etc.) on the premises to be used in their menus or offerings. The system will support whatever growing sequence is desired by the gardener.

The invention herein solves, among others, the following problems:
It provides portability not available in raised beds
It has a small footprint for providing production gardens in smaller spaces, that is it provides for a raised bed-like production growing environment on rooftop, deck, patio etc. (i.e. no yard needed)
It is self-watering and you can see at a glance if watering (i.e. reservoir refill) is required and overwatering is avoided.
It is easy to add water soluble or other fertilizer in the right amounts throughout growing season.
The removable components make it easier to succession plant in terms of removing exhausted crops and prepping for new ones.
It provides one system that takes plants from seed to cold weather crop harvest without the need to transplant thereby minimizing shock to plants.

The system is comprised of a set of interlocking frames, flat panels (perforated, clear vented cover, planting guides/weed cover), reservoir and tubing (wicking tubes, support scaffold) that when combined will create a growing system to take plants from seed to harvest.

A typical progression in certain embodiments might be as follows:
1. Create a seed starter tray that is used to start seed
2. Then combine the seed starter with a cold frame to harden plants off
3. Once hardened remove the cold frame top and seed starter is combined with additional frames to form raised beds and support scaffolding can be added for plant support for the active production garden
4. Once primary growing season is over replant the garden with cold weather crops and bring back the cold frame for protection against frost.

Additional optional accessories or devices may be available. A list (not exhaustive) of such devices that will be recognized by those skilled in the art include: a grow light attachment that could be attached to the support scaffolding for example during seed starting. Also a “greenhouse” attachment that may be made of planting fabric that fits over the support scaffolding to protect plants, or in other embodiments a bubble top that serves as a greenhouse that may snap into the frames (see description of frames). This system allows the user to have one easy convenient and common set of planting vessels that are modular and interchangeable and which may be used throughout the growing process with little or no disruptions to the plants.

Preferred embodiments of the disclosed invention may be comprised of the following components (see FIG. 7):
A set of at least 4 interlocking frames (figure shows 12).
A reservoir with a small extension that sits on the ground or is lowest to the ground.
A perforated flat panel that sits in the bottom of the frame and on top of the reservoir.
Wicking tubes.
A planting guide/weed cover that may also be used from the start (not shown in figure).
Clear/cold frame cover with vents.
Support scaffolding (not shown in figure).

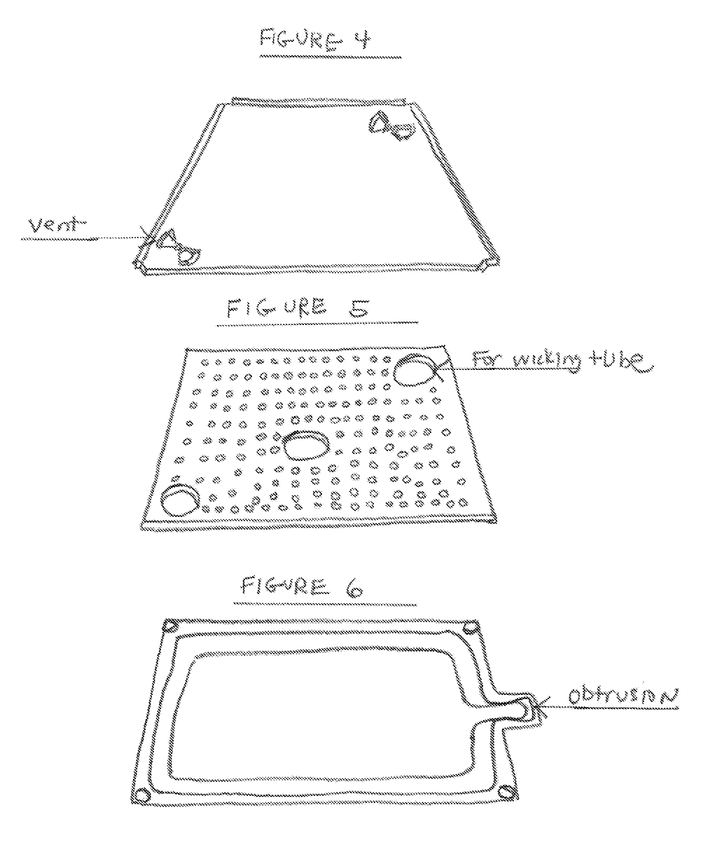

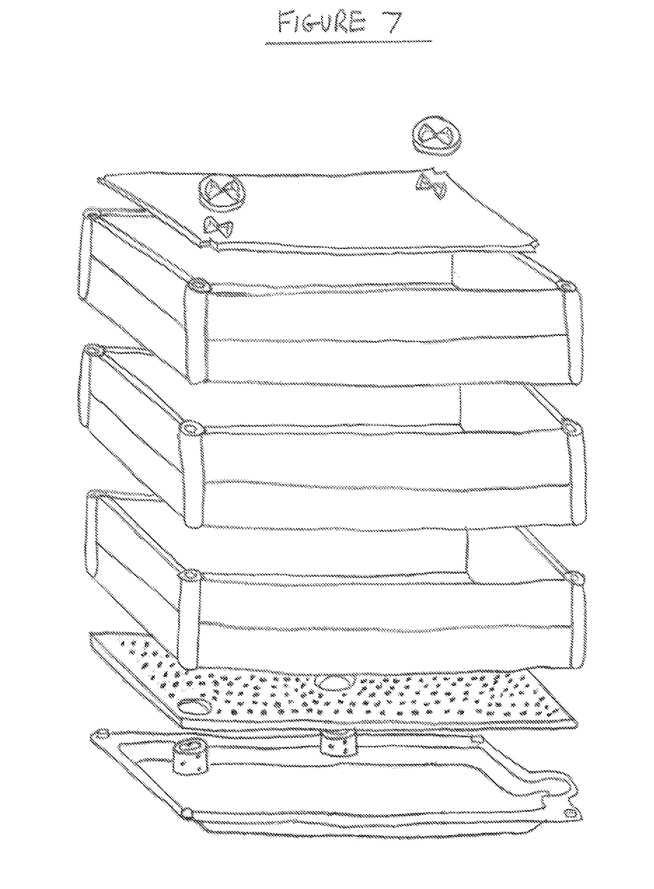

The components are then combined and recombined for the planting task at hand. One embodiment may be in the form of a kit, comprising the following:
A set of 8-16 (or more) 2′ by 4″ (or other size) interlocking frames, 4 frames are needed to form each raised bed component. Once formed the frames can be stacked upon each other to create the depth needed for the planting scenario at hand. The frames have support lips/ledges running around the top and bottom for the flat panel components (perforated, covers, etc.) and holes in each corner for the scaffolding or bubble top.
The above frame can be used for seeding or a smaller one (e.g. 2″ in height) can also be used for that purpose.
The reservoir sits on the ground or lowest to the ground (See FIG. 6) and is the same size as a set of connected frames the frame connects to the reservoir. The reservoir holds about 3 gallons of water and has an obtrusion on one side for adding water and/or fertilizer or other nutrients.
A perforated flat panel that sits in the bottom of the connected frames and on top of the reservoir. The perforated flat panel (See FIG. 5) is filled with holes to aerate the soil and to connect with the wicking tubes. During seeding since less soil is needed (and therefore not as heavy) a reinforced cardboard perforated panel (potentially embedded with slow release fertilizer) can be used. The cardboard would eventually breakdown during full grow season.
Wicking tubes (See FIG. 3) sit in the reservoir and connect into the perforated flat panel to both provide support for the perforated flat panel and when filled with soil they will “wick” water up into the main soil bed and to the plant roots. They can be 2-3″ in diameter and 1-2″ in height, but other dimensions can be suitable. At least one is needed.
Planting guide/weed cover can also be used from the start, this guide is reinforced weed paper with precut holes (different variations available depending on size of plant) that fits on top of the connected frames and guides planting while thwarting weeds, it can also be embedded with slow release fertilizer.
Clear/cold frame cover with vents (See FIG. 4). This fits in the top of the connected frames and serves as humidity containment and protection during seed starting and protection against frost and other climate conditions during plant hardening and for fall planting. The cover has two vents that can be opened or closed depending on the weather, e.g. open during day but close at night when it gets cold or frost expected.
Support scaffolding can be made from ½″ PCV or other similar type material and assembled using typical PCV or other similar type connectors found in home improvement stores. This is fitted into holes in each corner of the frames and goes down to the ground. The scaffolding is then used to tie supports for plants such as tomato and pepper or others or can be used to support greenhouse type covering.

One example of the basic manner of using the Modular Growing System in a particular embodiment is as follows:
1. Find indoor or outdoor location. First create seed starter configuration (reservoir, cardboard perforated panel, wicking tubes, two raised bed components (i.e. 8 frames connected), clear cover). Fill with enough growing medium for seed starting. Use seed guide (optional) appropriate to what is being planted and plant seeds per seed package instructions. Water from top once and fill reservoir, cover with clear top with vents closed. Place under grow lights or in sunny location.
2. When seeds sprout remove clear cover, when seeds reach good height, place empty frame set/raised bed component on top with clear cover with vents open as appropriate for weather, place unit outside (you may have to empty reservoir to move which can be done by holding a bucket under the obtrusion on the reservoir and tilting towards bucket to allow water to drain) to harden plants.
3. When plants are hardened remove cover and take seed starting frame set off reservoir and put new frame sets/raised bed components(s) (1 or 2 depending on depth needed for plants) and permanent (i.e. not cardboard) perforated flat panel on reservoir and fill with container mix (approximately 40-50 quarts, reusable), water on top and replace the seed starter frame set on top so plants can grow to depth needed. The cardboard perforated flat panel used for seed starting will breakdown over time. For larger plants (e.g. tomatoes, peppers, etc.) the support scaffolding can be assembled and used to support the plants when they reach maturity using twine or similar.
4. Once plants are done producing remove the top frame set/raised bed component, clean, prepare bottom frame set for planting and plant a cold weather crop, then use empty frame set/raised bed component and clear cover as a cold frame (open/closing vents depending on weather conditions).

This is the standard Modular Growing System configuration but it can conform to gardener's preferences and type of plants being grown.

The system is a modular system comprised of interlocking frames and that allow for at least the following:
Easily going from one planting stage to the next with minimal shock to plants (typically you start seeds in small planters and then transplant them sometimes a few times as they get bigger, here you just drop the seed starter frame set onto the full garden frame set for full growing depth)
Ease of seeing if watering is needed and avoidance of overwatering
The production aspect of raised beds in urban/commercial setting
Providing a new, improved and more convenient method for home vegetable gardening
The ability to save time and money with one modular system that does it all
The ability to get more out of your garden by going seamlessly from one stage to the next
The ability to save room, compact production gardening for the urban dweller

Herein starting seeds refers to the process of planting seeds indoors in a climate controlled area or container with a growing medium designed for that purpose. Herein hardening off plants refers to the process of getting plants that have been seed started indoors acclimated to the outside by leaving them out and exposed during the day but covering at night or during adverse weather.

The phrase “in one embodiment” is used repeatedly. The phrase generally does not refer to the same embodiment; however, it may. The terms “comprising,” “having” and “including” are synonymous, unless the context dictates otherwise. The following illustrations of various embodiments use particular terms by way of example to describe the various embodiments, but this should be construed to encompass and provide for terms such as “method” and “routine” and the like.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way. The characteristics and utilities of the present invention described in this summary and the detailed description below are not all inclusive. Many additional features and advantages will be apparent to one of ordinary skill in the art given the detailed description.

1. A portable, modular growing system with interchangeable parts comprising:
at least 4 interlocking frames that comprise the raised bed component;
a reservoir that sits on the ground or is lowest to the ground, said reservoir further comprising a small obtrusion;
a clear frame with vents or a cold frame cover with vents;
a perforated flat panel that sits in the bottom of the connected frames and on top of the reservoir; and at least one wicking tube.

2. The system of claim 1, wherein each interlocking frame is a largely flat and rectangular piece with a complementary interlocking structure at each end, and wherein the reservoir that sits on the ground or is lowest to the ground comprises a flat rectangular surface with an upward extending lip surrounding said flat surface on all sides sufficient to contain liquid, and said reservoir component further comprising at least one obtrusion of varying size continuous with the reservoir bottom and surrounding lip.

3. The system of claim 2, wherein the perforated flat panel that sits in the bottom of the frame set and on top of the reservoir is a largely flat and rectangular grate with at least one hole for holding a wicking element, said panel being porous in nature, and wherein the wicking tube is a wicking tube comprising a circular vertically aligned open ended tube piece with at least one pore along its side.

4. The system of claim 3, wherein either the clear frame or the cold frame cover comprises: a flat and largely rectangular cover piece made of substantially clear material with at least one vent, and wherein the perforated flat panel is made of cardboard or of another biodegradable material for seed starting and plastic for production garden configuration.

5. The system of claim 4, further comprising support scaffolding.

6. The system of claim 5 assembled as one or more of the following: a seed starter, a production garden, a cold frame, a container garden, a self-watering garden, or a raised bed.

7. A growing system that may take plants from seed to harvest comprising the system of claim 5.

8. The system of claim 5 wherein the system is used to accomplish a complete growing progression, said progression comprising:
starting seeds with the seed starter tray;
combining the seed starter with a cold frame top to harden plants off;
after hardening removing the cold frame top, then combining the seed starter with at least
one raised bed and the support scaffolding (depending on type of plants) to create an active garden; and
after the primary grow season, replant with cold weather crops and install the cold frame once more.

9. The system of claim 5, further comprising at least one of the following: a grow light attached to the device; a greenhouse attachment comprising planting fabric attached to the support scaffolding and over the planting area; a greenhouse attachment comprising a clear bubble shaped top that snaps into the frames; or an automatic watering device that releases water at timed intervals.

10. A method of growing plants comprising the system of claim 5, and further comprising the follow steps:
a. Create a seed starter tray that is used to start seed
b. Then combine the seed starter with a cold frame to harden plants off
c. Once hardened remove the cold frame top and seed starter is combined with additional frames to form raised beds and support scaffolding can be added for plant support for the active production garden
d. Once primary growing season is over replant the garden with cold weather crops and bring back the cold frame for protection against frost.

11. claim 1, further comprising a planting guide or weed cover.
